(19) United States
(12) Patent Application Publication
(10) Pub. No.: US 2004/0068069 A1
(43) Pub. Date: Apr. 8, 2004

(54) Method for making acrylonitrile fibers

(75) Inventors: Martine Cerf, Breuil Magne (FR); Damien Colombie, Maisons Laffitte (FR); Tembou Denis N'Zudie, Vienne (FR)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: ATOFINA, S.A.

(21) Appl. No.: 10/375,052

(22) Filed: Feb. 28, 2003

Related U.S. Application Data
(63) Continuation of application No. PCT/FR01/02611, filed on Aug. 14, 2001.

(30) Foreign Application Priority Data
Apr. 29, 2000 (FR) 01/11016

(51) Int. Cl. C08F 120/42

(52) U.S. Cl. 526/297

(57) ABSTRACT

The invention concerns a method for making acrylonitrile fibers. More particularly, it concerns a method for making acrylonitrile fibers characterized in that it is carried out in the presence of at least an azocarboxylic acid ester.

### FIELD OF THE INVENTION

The present invention relates to a method for producing acrylonitrile-based polymers. More particularly, its subject is a method for making acrylonitrile-based fibers.

### BACKGROUND OF THE INVENTION

Acrylonitrile-based fibers are useful not only as fibers for clothes, but also as carbon fiber precursor and as fabric for industrial filtering media, tent cloth, sail cloth, sewing thread, material for reinforcing cement as a replacement for asbestos, as filtering medium in the form of a membrane or of hollow fibers which is used in the medical field and as a gas-tight film.

The expression acrylonitrile-based polymers is understood to mean acrylonitrile homo- and copolymers, the latter containing at least 70% by weight of acrylonitrile and at least one unsaturated monomer which is copolymerizable with acrylonitrile, such as for example methyl (meth)acrylate, ethyl (meth)acrylate, n-, iso- or t-butyl (meth)acrylate, 2-ethylhexyl (meth)acrylate, acrylic acid, methacrylic acid, itaconic acid, α-chloroacrylonitrile, 2-hydroxy-ethylacrylonitrile, hydroxyalkyl (meth)acrylates, acrylamide, methacrylamide, vinyl chloride, vinylidene chloride, vinyl bromide, vinyl acetate, vinyl propionate, (meth)acrylamides and derivatives thereof, sulfuric acid monomers, styrene and allyl alcohols.

Preferably, the acrylonitrile copolymers contain at least 85% by weight of acrylonitrile and at least one unsaturated monomer which is copolymerizable with acrylonitrile. This monomer may be hydrophobic or hydrophilic.

Conventional methods for the industrial manufacture of acrylonitrile-based polymers comprise the precipitation polymerization method using a polymerization redox catalyst composed of a persulfate and an acid sulfite in an aqueous medium, the method of polymerization in homogeneous solution using a solvent such as dimethyl sulf oxide, dimethylformamide, dimethylacetamide, ethylene carbonate and gamma-butyrolactone and the method of polymerization in emulsion. Reference may be made in this regard to the article “Polymérisation of acrylic fibres” on pages 334-338, volume 1 of Encyclopedia of Polymer Science, 1985.

According to this article, although thermal activators such as azobisisobutyronitrile (AIBN), ammonium persulfate or benzoyl peroxide can be used in polymerization in homogeneous solution, they are however slow to react at the temperature at which the polymers intended for the textile field are made. These activators therefore require a long polymerization time and are mainly used in batch and semicontinuous processes.

Moreover, recent work in this field shows that acrylonitrile polymer fibers having particular properties can only be obtained with activators such as azobisisobutyronitrile or azobisdimethylvaleronitrile (EP 180975, JP-A-62 256807, JP-A-63-66317, JP-A-6385108 and U.S. Pat. No. 4,540,754).

While despite the slowness of the reaction at low temperature, AIBN or azobisdimethylvaleronitrile is of commercial interest for the particular quality of the acrylonitrile-based polymer fibers, these activators are however under threat. Indeed, these activators lead to toxic products during their decomposition. Thus, azobisisobutyronitrile decomposes to give TMSN (tetramethyl succinonitrile) [NC-C(CH₃)₂-CN], a highly toxic product.

### SUMMARY OF THE INVENTION

The applicant has now observed that by polymerizing acrylonitrile with at least one unsaturated monomer which is copolymerizable with acrylonitrile in the presence of an azocarboxylic acid ester, neither the formation of toxic decomposition products mentioned above nor even of cyanated compounds is observed.

### DETAILED DESCRIPTION OF THE INVENTION

The present invention therefore provides a method for making acrylonitrile-based polymers, characterized in that the procedure is carried out in the presence of at least one azocarboxylic acid ester of formula (I),

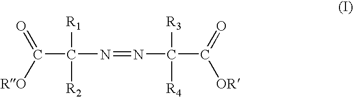

in which:

R₁ R₂, R₃, and R₄, which are identical or different, independently comprise:

linear or branched alkyls having from 1 to 9 carbon atoms, preferably from 1 to 4 carbon atoms, optionally substituted with one or more substituents comprising hydroxyl, C₁ to C₆ alkoxy and halogen substituents;

C₃ to C₁₂ cycloalkyls, optionally substituted with one or more substituents comprising C to C₆ alkyl, C₁ to C₆ alkoxy, hydroxyl and halogenated groups;

aralkyls optionally substituted with one or more substituents comprising C₁ to C₆ alkyl, C, to C₆ alkoxy, hydroxyl and halogenated groups;

aryls optionally substituted with one or more substituents comprising C, to C₆ alkyl, C₁ to C₆ alkoxy, hydroxyl and halogenated groups;

it being possible for at least one of the combinations R₁-R₂ and R₃-R₄ optionally to form an aliphatic ring; R″ and R′ are identical or different from each other and independently comprise linear or branched C₁ to C₁₀, preferably C₁ to C₄, aliphatic radicals.

In addition, these azocarboxylic acid esters have a low melting point and the step of predissolution in a solvent before adding to the polymerization reactor is not necessary. The preferred azocarboxylic acid esters are those in which R″ and R′ represent methyl or ethyl and in which R₁, R₂, R₃, and R₄ advantageously represent C₁ to C₄ alkyl groups.

The azocarboxylic acid ester particularly preferred is diethyl 2,2′-azobisisobutyrate, that is to say with R₁, R₂, R₃, and R₄ representing methyl and R′ and R″ representing ethyl. A mixture of diethyl 2,2′-azobisisobutyrate (DEAB) and dimethyl 2,2′-azobisisobutyrate (DMAB) with a content by mass of DEAB preferably greater than 50% is also preferred. Mixtures of DEAB, DMAB and methyl 2, ethyl 2′-azobisisobutyrate, with preferably a COOMe/COOEt molar ratio≦10, may be suitable.

The azocarboxylic acid esters of formula (I) may be prepared by a conventional two-step method comprising a first step of converting azonitrile, by reaction with an alcohol, in the presence of HC 1, according to the Pinner reaction, leading to the corresponding azoimino ether hydrochloride and a second step of hydrolysis in the presence of the hydrochloride thus obtained. They may also be prepared by improved methods as described in the documents DE 2 254 572, EP 80 275 and EP 230 586.

In addition, these esters may be prepared by reacting an azonitrile with an alcohol and hydrochloric acid in an aromatic solvent, with an HCI/azonitrile molar ratio>2 when the alcohol is methanol and >3 when the alcohol is ethanol or a higher alcohol.

The method for producing acrylonitrile-based polymers, according to the present invention, may be batchwise, semicontinuous or continuous. The polymerization in the presence of at least one azocarboxylic acid ester of formula (I) may be of the emulsion, suspension or mass type, in an aqueous medium or in solution in an organic solvent or a water/solvent mixture. Polymerization in suspension or in solution in an organic solvent or a water/solvent mixture is most often preferred.

When the polymerization is carried out in solution in an organic solvent or a water/organic solvent mixture, the solvent may be any solvent used for an acrylonitrile-based polymer, such as dimethylformamide, dimethylacetamide, dimethyl sulf oxide, ethylene carbonate, isopropanol and gamma-butyrolactone. The concentration of monomer(s) in the reaction medium may vary between 10 and 70% by weight.

When the polymerization is carried out in suspension, a surfactant or a dispersant may be present. These agents are in general water-soluble polymers such as water-soluble celluloses, poly-vinylpyrrolidone, polyacrylamide, polyoxyethylene, polycarboxylic acids, polysulfonic acids and polyvinyl alcohol. They are used in an amount of 0.1 to 3% by weight relative to the monomer(s). The monomer concentration represents between 15 and 60% by weight of the reaction mixture consisting of monomer(s), water and optionally surfactant or dispersant.

According to the present invention, the procedure may be carried out at a temperature between 20 and 120° C., preferably between 60 and 95° C., and advantageously between 40 and 95° C.

The quantity of azocarboxylic acid ester(s) used is preferably between 0.01 and 6% by weight relative to the monomer(s)

It is also possible to use a transfer agent such as mercaptans in order to adjust the molar masses of the polymers.

The polymers thus obtained may be spun into a fibrous material by conventional wet spinning, dry jet wet spinning or dry spinning techniques.

### EXAMPLE

The abbreviations used are as follows:

DEAB: diethyl 2,2′-azobisisobutyrate

AZDN: 2,2′-azobisisobutyronitrile marketed by ATOFINA

AMPS: 2-acrylamido-2-methylpropane sulfonic acid

There are introduced into a calorimetric reactor having a capacity of 2 liters, 33.4 g of water, 435.2 g of an aqueous solution containing 52% by weight of sodium thiocyanate, 97.3 g of acrylonitrile, 5.9 g of methyl acrylate and 1.47 g of AMPS. The mixture is then stirred at a speed of 400 revolutions/mm and heated to 80° C.

Although it is possible to introduce the DEAB directly into the reactor, for the trials to be comparable to the solid AZDN activators, the DEAB and the AZDN were dissolved beforehand in propionitrile. Thus, an AZDN solution was prepared with 1.59 g of AZDN in 20 g of propionitrile (el) and 1.59 g (e2) and 2.51 g (e3) of DEAB were mixed with 20 g of propionitrile.

1.79 g of e1 or e2 are then introduced into the reactor and then the remainder of e1 or e2 is poured in over 3 hours. As regards e3, 1.88 g are first introduced into the reactor, and then the remainder poured in over 3 hours.

The maximum instantaneous heat of polymerization Qr max (W), the total heat (KJ), the conversion of acrylonitrile (or monomers) and the final dry extract (D.E.) of the mixture for each sample (e1, e2, e3) are presented in table 1.

TABLE I

| | Qr max. | Conversion | Total heat | Final D.E. |
|---|---|---|---|---|
| | (W) | (%) | (kJ) | (%) |
| e1 | 69 | 91.7 | 258 | 54.3 |
| e2 | 54 | 83.0 | 247 | 52.9 |
| e3 | 84 | 90.2 | 308 | 54.0 |

1. A method for making acrylonitrile-based polymers, wherein the method is carried out in the presence of at least one azocarboxylic acid ester of formula (I), 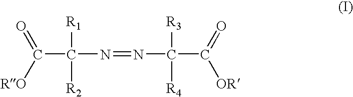
in which:
R₁, R₂, R₃, and R₄ are identical or different and independently comprise:
linear or branched alkyls having from 1 to 9 carbon atoms;
C₃ to C₁₂ cycloalkyls;
aralkyls;
aryls;
R″ and R′ are identical or different from each other and independently comprise linear or branched C₁ to C₁₀ aliphatic radicals.

2. The method of claim 1, wherein the azocarboxylic acid ester is diethyl 2,2′-azobisisobutyrate (DEAB).

3. The method of claim 2, wherein the DEAB is present in the form of a mixture with dimethyl 2,2′-azobisisobutyrate (DMAB).

4. The method of claim 3, wherein the content by mass of DEAB in the mixture is greater than 50%.

5. The method of claim 3, wherein the mixture contains methyl 2, ethyl 2′-azobisisobutyrate.

6. The method of claim 1, wherein the method is carried out in solution in an organic solvent or a water/organic solvent mixture.

7. The method of claim 1, wherein the method is carried out in suspension.

8. The method of claim 1, wherein azocarboxylic acid ester(s) used is in a quantity of between 0.01 and 6% by weight relative to the monomer(s).

9. The method of claim 1, wherein the method further comprises spinning the acrylonitrile-based polymers into fibrous materials after the acrylonitrile-based polymers are polymerized.

10. The method of claim 1, wherein said linear or branched alkyls have from 1 to 4 carbon atoms.

11. The method of claim 1, wherein said linear or branched alkyls are substituted with one or more substituents comprising hydroxyl, C, to C₆ alkoxy and halogen substituents.

12. The method of claim 1, wherein said cycloalkyls are substituted with one or more substituents comprising C₁ to C₆ alkyl, C₁ to C₆ alkoxy, hydroxyl and halogenated groups.

13. The method of claim 1, wherein said aralkyls are substituted with one or more substituents comprising C₁ to C₆ alkyl, C₁ to C₆ alkoxy, hydroxyl and halogenated groups.

14. The method of claim 1, wherein said aryls are substituted with one or more substituents comprising C₁ to C₆ alkyl, C₁ to C₆ alkoxy, hydroxyl and halogenated groups.

15. The method of claim 1, wherein at least one of the combinations R₁-R₂ and R₃-R₄ form an aliphatic ring.

16. The method of claim 1, wherein R″ and R′ are identical or different from each other and independently comprise linear or branched C, to C₄ aliphatic radicals.

17. The method of claim 5, wherein the mixture contains methyl 2, ethyl 2′-azbisisobutyrate with a COOMe/COOEt molar ratio≦10
